(19) United States
(12) Patent Application Publication
(10) Pub. No.: US 2024/0094345 A1
(43) Pub. Date: Mar. 21, 2024

(54) METHOD FOR EXTENDING THE EFFECTIVE RANGE OF A SENSOR AND A CORRESPONDING SENSOR SYSTEM

(71) Applicant: CONTIENENTAL AUTOMOTIVE GMBH, Hannover (DE)

(72) Inventor: Robert-Zsolt Kabai, Vecses (HU)

(73) Assignee: Continental Autonomous Mobility Germany GmbH, Ingolstadt (DE)

(21) Appl. No.: 18/266,158

(22) PCT Filed: Nov. 12, 2021
(86) PCT No.: PCT/EP2021/081533

§ 371 Date: Jun. 8, 2023

(30) Foreign Application Priority Data
Dec. 14, 2020 (EP) 20213749.3

(51) Int. Cl. G01S 7/48; G01S 17/86; G01S 17/931

(52) U.S. Cl. CPC G01S 7/4802; G01S 17/86; G01S 17/931

(57) ABSTRACT

A sensor system for a vehicle includes a first sensor setup having a first short-range sensor and a first long-range auxiliary sensor configured to provide an anchor point measurement. The system also includes a second sensor setup having a second short-range sensor, a second long-range auxiliary sensor configured to provide an anchor point measurement, and a long-range ground truth sensor. The sensors of first and second sensor setups each have a sensor range and provide sensor data for reflection detection. The system also includes a neural network. The neural network is configured to infer distances between an anchor point and other reflections out of the detection range of the short-range sensors by using a provided ground truth of the neural network.

### CROSS-REFERENCE TO RELATED APPLICATIONS

This application is a national stage application, filed under 35 U.S.C. § 371, of International Patent Application No. PCT/EP2021/081533, filed on Nov. 12, 2021, which claims priority to European patent application No. 20213749.3, filed on Dec. 14, 2020, each of which is incorporated by reference.

### TECHNICAL FIELD

The technical field relates to a computer-implemented method for extending the effective range of a short-range sensor and sensor system.

### BACKGROUND

Modern means of transportation such as motor vehicles or motorcycles are increasingly outfitted with driver assistance systems which sense the surroundings by means of sensor systems, recognize traffic situations, and assist the driver, e.g., by braking action or steering action or by emitting an optical or acoustical warning. Radar sensors, lidar sensors, camera sensors, or the like are generally used as sensor systems for detecting surroundings. Inferences about the surroundings can subsequently be drawn from the sensor data determined by the sensors, e.g., so that an object classification and/or surroundings classification or an environment model can be prepared. Furthermore, detection of surroundings is virtually indispensable in the field of (semi-)autonomous driving so that there is a particular interest in advancing and further developing the corresponding systems. Furthermore, curve detection based on object detection is very important precisely in the field of (semi-)autonomous driving because it is very difficult to implement autonomous planning of trajectories along the route without curve detection of this kind.

Perception models for autonomous driving use various sensors including cameras, lidar sensors, and radar sensors. As each type of sensor has highly different characteristics and supply very different information about the vehicle's surroundings, fusion techniques are sometimes applied to merge the extracted information from all. Most fusion techniques used rely on what's called “late fusion” where each sensor's information is processed individually and the extracted semantic information from all of them are merged with sensor fusion, e.g., Kalman Filters at a later stage. Such techniques are robust for individual sensor failure, but many times suffer from the drawbacks of each individual sensor. In lidar super-resolution setups, the lidar and camera information is fused at an early stage to enhance the typically low resolution of the lidar unit.

A big drawback of some lidar sensors is the limited measurement range, for example, approximately 20 m, which makes its use very limited, thus it makes it impossible to safely use in driving scenarios involving importance long-range or highspeed scenarios. In the case of high speeds there would be not enough response time for the vehicle if an object approaches the vehicle with highspeed and is invisible for the lidar sensor for up to the last short time period.

In “RegNet: Multimodal Sensor Registration Using Deep Neural Networks” (N. Schneider et al.; 2017) a deep convolutional neural network (CNN) is presented which infers a 6 degrees of freedom (DOF) extrinsic calibration between multimodal sensors, exemplified using a scanning lidar and a monocular camera. The CNN casts all three conventional calibration steps (feature extraction, feature matching and global regression) into a single real-time capable CNN, wherein the described method does not require any human interaction and bridges the gap between classical offline and target-less online calibration approaches as it provides both a stable initial estimation as well as a continuous online correction of the extrinsic parameters. During training it is suggested to randomly decalibrate the system in order to train the CNN to infer the correspondence between projected depth measurements and RGB image and finally regress the extrinsic calibration.

As such, it is desirable to present a novel method for a sensor of a vehicle with which the effective range of the sensor is improved in a simple and economical manner.

### SUMMARY

The disclosure provides a method for lidar range enhancement using Deep Learning methods and a combination of supplemental sensors which are different in the training setup and the inference (production vehicle) setup. The proposed method may be a computer-implemented method for extending the effective range of a short-range sensor. The method includes a first sensor setup for a vehicle (production vehicle), having a short-range sensor and at least one long-range auxiliary sensor which provides an anchor point measurement. Furthermore, a second sensor setup for a training vehicle includes a short-range sensor, a long-range auxiliary sensor which provides an anchor point measurement, and a long-range ground truth sensor. The sensors of first and second sensor setup have a sensor range and provide sensor data for reflection/object detection. The range extension is done with a neural network. The neural network is trained by: detecting reflections, hits or objects in the surrounding of the vehicle by using sensor data of second sensor setup, determining an anchor point of an reflection or object which is out of an effective range of short-range sensor of second sensor setup by using anchor point measurement of long-range auxiliary sensor of second sensor setup, providing ground truth by determining the distances between the anchor point and the other reflections or objects by using the sensor data of long-range ground truth sensor. The method is executed on basis of the neural network by: detecting reflections or objects in the surrounding of the vehicle by using sensor data of second sensor setup, determining an anchor point of an reflection or object which can be out of or in an effective range of short-range sensor of first sensor setup by using anchor point measurement of long-range auxiliary sensor of first sensor setup, determining the distances between the anchor point and other reflections/objects in the effective range of short-range sensor by using the sensor data of short-range sensor and inferring the distances between the anchor point and other reflections/objects out of the effective range of short-range sensor by using the provided ground truth of the neural network. The method solves the challenges in situations of reflections/objects being outside of the range of the short-range lidar mounted on the vehicle. The disclosure also provides a cost-sensitive sensor setup for production cars as range-extension makes the production vehicle be able to use a less expensive short-range lidar in cooperation with cost effective complementary sensors reconstruct the 3D environment around the vehicle even up to long ranges, which is traditionally only possible using costly and elaborate lidars.

According to a one exemplary embodiment, the short-range sensor in the first and/or the second sensor setup is a short-range lidar sensor, such as a short-range flash lidar sensor.

Furthermore, the long-range auxiliary sensor which provides an anchor point measurement in the first and/or the second sensor setup can be a radar sensor or a long-range lidar sensor.

The long-range auxiliary sensor may include a single-beam or a multi-beam configuration.

According to one exemplary embodiment, the first sensor setup and/or the second sensor setup includes a camera which provides images and/or pixels as sensor data which are also used as input for the neural network.

Furthermore, the neural network may infer the location of camera pixels which have no other input sensor data or anchor point measurement associated.

The long-range ground truth sensor may be a long-range ground truth lidar sensor capable of wide field of view and long-range measurements.

In addition, a sensor fusion of sensor data of the sensors of first sensor setup (e.g., short-range sensor, long-range auxiliary sensor, and camera) may be done to enhance the reflection/object detection.

Furthermore, the present disclosure provides a system, particularly a sensor system or a data processing system comprising sensors, with a short-range sensor, a long-range auxiliary sensor, and a computer, wherein the system is adapted to extend an effective range of the short-range sensor based on a method as described herein.

The short-range sensor may be a short-range lidar sensor such as a short-range flash lidar sensor and the long-range auxiliary sensor may be a (long-range) radar sensor or a long-range lidar sensor.

Furthermore, the system can include a camera, wherein the camera provides images or pixels as sensor data for reflection/object detection. The camera may be used for a kind of fusion between camera and lidar/radar sensor. Sparse anchor points and dense image textures can be used for dense distance predictions.

According to a practical embodiment, the sensors of the system may be arranged together with the camera in one physical housing to create a kind of compact sensor combination. As a result, installation space requirements may be reduced to a particular degree.

The system can also be characterized in that the short-range lidar sensor and the long-range lidar sensor and/or the camera having the same frame rate. In a practical manner the camera and the flash lidar frame rate synchronization is already carried out in the factory process.

The present disclosure further describes a computer program with program code for implementing the method as described herein when the computer program is executed in a computer or other programmable computing means (e.g., a computing device comprising a processor, microcontroller or the like) known from the art.

The present disclosure additionally describes a computer-readable storage medium which includes instructions which prompt the computer on which they are executed to carry out a method as described herein.

Surprisingly, it has been further shown that the method described herein is also applicable to other sensor types, e.g., camera sensors, lidar sensors, or ultrasound sensors, when suitable input data are used and the training is adapted to the latter in a corresponding manner. Furthermore, the disclosure may be used in the field of Semantic Segmentation, Lost Cargo Detection, Emergency Breaking, and other important functions for autonomous driving.

Within the meaning of the disclosure, the term “effective range” describes the range within any “useful” measurable information is returned. Common lidar sensors have two types of ranges, a maximum range and a (effective) range given at x percent albedo (in particular at 10% albedo). The effective range (at x % albedo) is the relevant range for the described method—the physical maximum range is not relevant here, because the returned signals here are too weak to register and measure. Furthermore, a detection algorithm, a semantic segmentation or pose estimation or other final tasks can be used later on to improve the detection range, the object detection, and so on.

Within the meaning of the disclosure, sensors are distinguished by their range. For example, there are short-range and long-range sensors, wherein short-range sensors have an (effective) range up to 30 m (For example, High Flash Lidar Sensors with a range up to 20 m at 10% albedo). Both the high-resolution ground truth sensor and the single beam sensor could be a long-range sensor depending on the desired final range extension of the short-range sensor. Long-range lidars may contain information up to 120 m and single (or low #multi-)beam additional beam lasers can be used with an effective range of 40 m for a 40 m extension of a short-range sensor with 20 m effective range or laser with a 80 m effective range for a 80 m extension of a short-range sensor with 20 m effective range. In other words, about 30 m or less is short-range more than 30 m is long-range. Furthermore, the method may also be used for extending the effective range of a sensor with an effective range with more than 30 m by using sensors as long-range sensor and long-range ground truth sensor with much higher effective ranges (e.g., long-range sensor with an effective range of 120 m or 150 m can be used fora 120 m or 150 m extension of a sensor with effective range of 50 m.

Within the meaning of the disclosure, the term “artificial intelligence” (AI) includes technologies which are capable of solving problems that normally require a kind of “human intelligence”.

Within the meaning of the disclosure, the term “machine learning” (ML) describes the use of algorithms to analyze data, to learn from these data and to then make a determination or prediction about something (not yet visible). In this regard, monitored learning as well as unmonitored learning can be applied. Among other things, the labeling strategy or labeling of data can be critically important for the analysis of the data.

Within the meaning of the disclosure, the term “training” describes the adaptation of parameters of a model in the field of machine learning such that a previously established erroneous measurement is smaller for the adapted model.

Within the meaning of the disclosure, the term “deep learning” (DL) includes a cascade of a plurality of layers of nonlinear processing units (mostly artificial neural networks) for extracting and transforming features (or extracting and transforming parameters).

The terms “artificial neural network” (ANN) and “convolutional neural network” (CNN) includes networks of artificial neurons which, expressed abstractly, are linked as in a nervous system of a living being with respect to information processing. The neurons can be represented as nodes and their connections as edges in a graph. The rearmost (node) layer of the network is designated as the output layer and “invisible” (node) layers located in front are designated as hidden layers. Artificial neural networks of this kind may be constructed of one layer (one output layer), two layers (an output layer and a hidden layer to improve the abstraction) or multiple layers (at least one output layer and a plurality of hidden layers for improving abstraction). In addition, they can be configured as feed-forward and/or with back-propagated edges (recurrent connections) with respect to their data transmission (feedback network).

The term “Inference” is used to describe a reasoning or a process whereby conclusions can be drawn from given facts and rules. If artificial intelligence (AI) is concerned, it is an application or a system that has been trained with the help of neural networks. These systems are not supposed to “learn”, but to apply what they have learned based on inference.

Within the meaning of the invention, the term “computer-implemented method” describes a flow planning or procedure which is realized and carried out based on a data processor. The data processor, e.g. a computer, a computer network or another programmable device known from the prior art, can process data by means of programmable calculation rules. With respect to the method, essential properties can be realized, e.g., by means of a new program, new programs, an algorithm, or the like.

### BRIEF DESCRIPTION OF THE DRAWINGS

The disclosed subject matter will be described in more detail in the following referring to expedient embodiment examples. Therein:

FIG. 1a shows a simplified schematic representation of an embodiment of a training vehicle;

FIG. 1b shows a simplified schematic representation of an embodiment of a production vehicle;

FIG. 2a shows a simplified schematic representation of a detection situation for a single-beam setup proposal for a production vehicle with a first sensor setup (inference time setup);

FIG. 2b shows a simplified schematic representation of a detection situation for a single-beam setup proposal for a training vehicle with a second sensor setup (recording time or training setup);

FIG. 3a shows a simplified schematic representation of a detection situation for a multi-beam setup proposal for a production vehicle with a first sensor setup (inference time setup);

FIG. 3b shows a simplified schematic representation of a detection situation for a multi-beam setup proposal for a training vehicle with a sensor setup (recording time setup), and

FIG. 4 shows a simplified schematic view of a flow diagram of an inference setup of a production vehicle and the training setup of a recording vehicle.

### DETAILED DESCRIPTION

The disclosure includes a method for Neural Network based range extension of a sensor, in particular a short-range lidar sensor, using different complementary sensors for training with a training and an inference (production vehicle) setup. For inference (production vehicle) using a simple and cheaper sensor unit, for example a secondary long-range auxiliary sensor unit (e.g. a single beam lidar or a radar) that provides a small point number (even a single point or up to a few) of Anchor Point measurements for longer distances and a camera providing image information. The complementary long-range auxiliary sensor providing the Anchor Point measurement should have a larger range than the short-range lidar for which the range extension is done. In the case of some radar units have more than one beam thus in that case more than one Anchor Point is used, typically a number between one and ten resulting in a single beam or multiple beams with specific angles between beams. For training setup, the data is recorded using all three previously mentioned sensors (short-range lidar, long-range auxiliary sensor and camera) plus an additional long-range ground truth lidar sensor capable of wide field of view and long-range measurements.

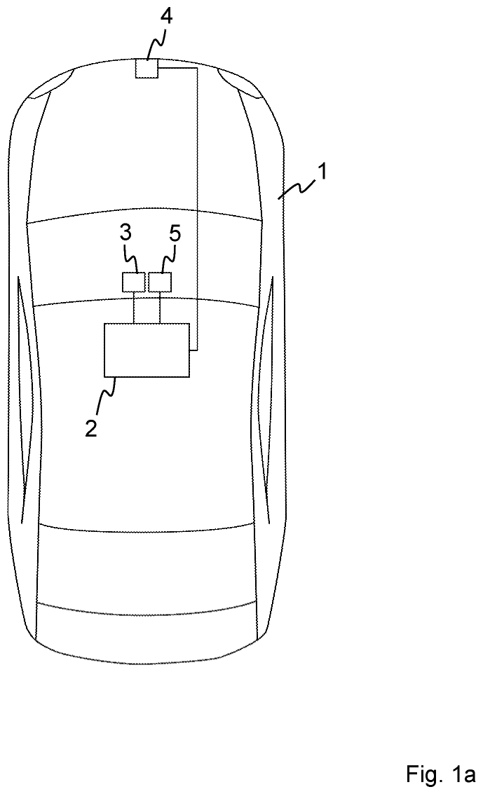

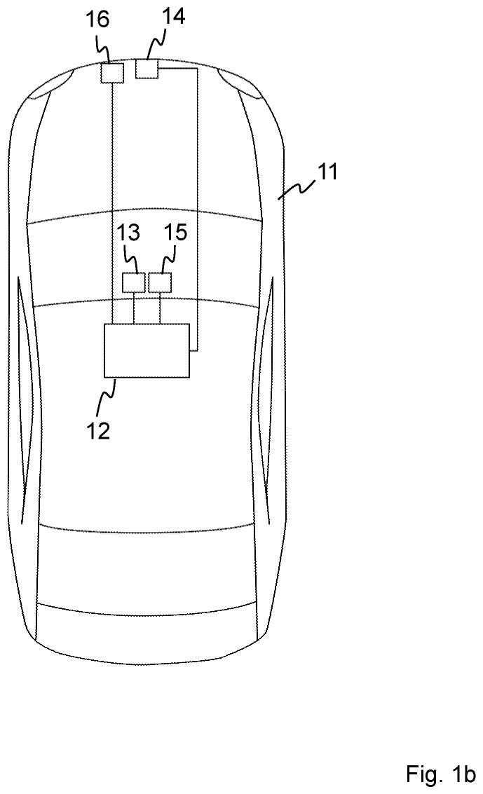

Reference number 1 in FIG. 1 designates a production vehicle having a control unit 2 (ECU, Electronic Control Unit or ADCU, Assisted and Automated Driving Control Unit), by which a (partly) automated control of the ego-vehicle 1 can be effected, e.g., in that the control unit 2 can access the actuators (brake, acceleration, steering) of the vehicle 1. Furthermore, the vehicle 1 includes a first sensor setup (inference setup) and has sensors for capturing the environment: a short-range lidar sensor 3, a long-range radar sensor 4, and a front camera 5, the sensor data of which are utilized for recognizing the environment and objects so that various assistance functions such as, e.g., the emergency baking system (EBA, Electronic Brake Assist, Automatic Cruise Control (ACC), Lane Keeping Support, or respectively a lane departure warning system (LKA, Lane Keep Assist) or the like can be realized. The short-range lidar can be a (high) flash lidar sensor (HFL) which is a very sensitive sensor that do not require moving parts like rotating mirrors. The flash lidar detects the entire environment of the vehicle by using a single laser flash (“Flash lidar”) and comprises for this several special photodiodes (e.g. single-photon avalanche diodes—SPAD), wherein a rectangular measuring field is illuminated—not only one point or a few points are illuminated as in classic lidar sensor setups—so that the flash lidar has a higher resolution than other lidars but also a limited measurement effective range (short-range). The radar sensor 4 is a long-range radar sensor which guarantees capturing of the surroundings even at higher speeds (e.g. by a wide range of >200 m). According to another preferred embodiment of the invention a low beam count individual static beam lidar can be used instead of radar sensor 4 as long-range auxiliary sensor. Furthermore, distance information is allocated to the detected reflections or objects by means of a radar sensor 4 (distance determination or respectively distance measurement), e.g. on the basis of the configuration of the radar sensor according to a FMCW (Frequency Modulated Continuous Wave) method, by means of doppler radar or the like. The assistance functions are executed via the control unit 2 or respectively the algorithm stored therein. Reference number 11 in FIG. 1b designates a training vehicle having a second sensor setup (training setup) as the production vehicle 1 of FIG. 1a (Control Unit 12, short-range Lidar sensor 13, long-range radar sensor 14 and camera 15) except a long-range ground truth sensor in particular a long-range ground truth lidar sensor 7 which is additionally arranged in training vehicle 11.

Conventional long-range lidars having typically inconveniences like the large size, the mechanical moving parts and the rolling shutter effect and aside this they are normally expensive which makes the sensor economically unfeasible to use on a production vehicle. The method may utilize all sensors on the recording car or training vehicle 1b setup for training data of the Neural Network in the following way: The Neural Network uses supervised learning to reconstruct the part of the 3D environment around the vehicle which is normally outside of the range of the short-range lidar 3. The input of the Neural Network includes the information from the three sensors listed in the production vehicle setup (short-range lidar 3, long-range auxiliary sensor 4 and camera 5). The ground truth of the Neural Network includes the information recorded by the expensive wide field of view and long-range lidar and the single (or limited few) beam measurements of the long-range auxiliary sensor (e.g. single beam lidar or radar sensor 4). The long-range ground truth measurements contain all the information for direct distance measurements between reflections/objects around the vehicle, even outside the limited range of the short-range lidar 3.

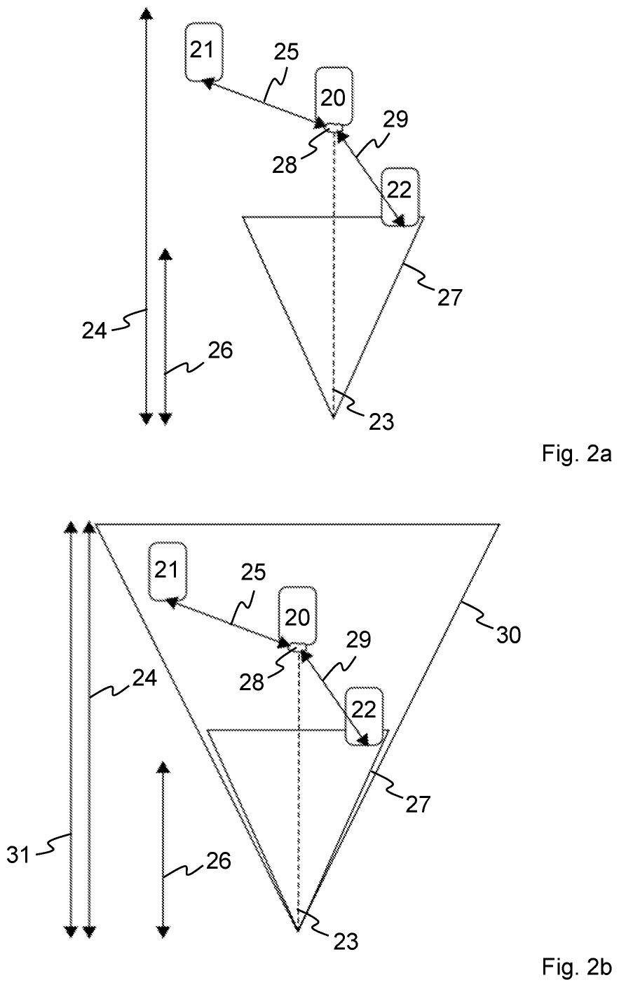

For the input of the Neural Network the short-range lidar provides a number of denser, more detailed 3D measurements up to the sensor's range, and only a very few (even a single) long-range beam measurement coming from the complementary sensor used as 3D Anchor Point(s) possibly outside of the short-range lidar's range, especially if multiple beams and thus Anchor Points are provided. All Anchor Points (and all short-range lidar measurements) provide a fixed measurement for a subset of the real world surrounding the vehicle in both recording and production setups, as shown in FIG. 2a (interference time setup for production vehicle 1) and FIG. 2b (recording time setup for training vehicle 11). In FIGS. 2a and 2b Reference numbers 20, 21, 22 designate reflections (hits or objects) detected by the sensor system. The single lidar (or radar) beam 23 is send by radar sensor (single/multi beam long-range lidar/radar) with effective range 24. The Neural Network infers the location of camera pixels which have no input lidar or Anchor point measurement associated (inferred distance 25 between reflection 10 and reflection 11). Outside of the limited effective range 26 (and corresponding lidar coverage 27) of the short-range lidar the Anchor Points 28 are the reference for calibrating relative distances in the scene (measured distance 29 between reflection 20 and reflection 22). Typical Depth Estimation does not have reference points to calibrate the distance estimations thus is very inaccurate, giving only a general high-level relative shape or relative structure of the scene. Thus, in the invention's range extension setup the remaining unseen area by neither the input lidar, neither the long-range beam sensor can be reconstructed with high accuracy using anchor points 28 and the long-range ground truth measurements available.

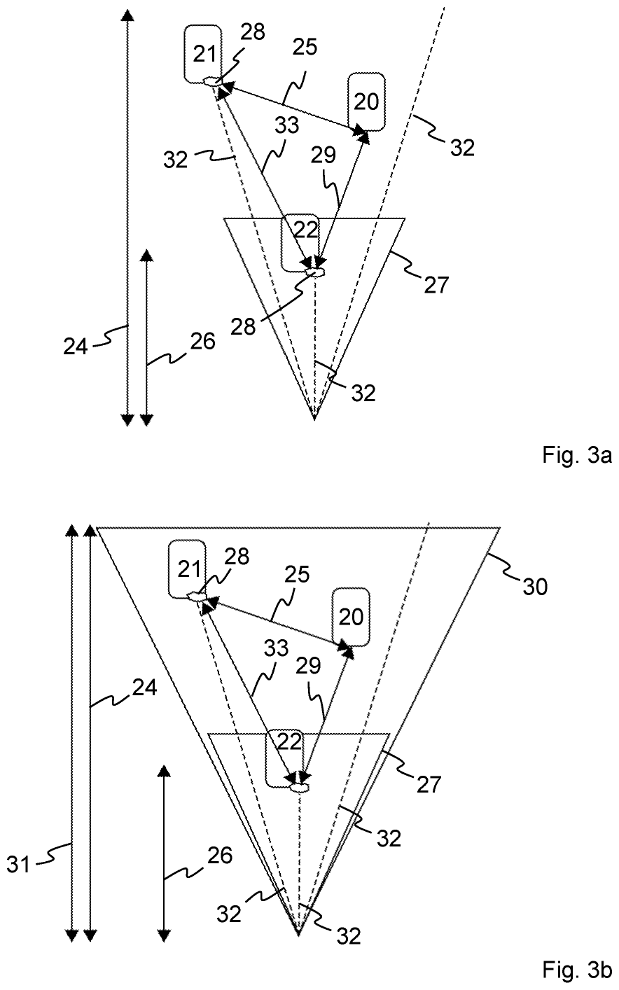

In case of a complementary sensor with multiple beams 32, the training is done in such a way to optimize the accuracy of the predicted distance between the closest observed anchor point (as shown in FIG. 3). The Neural Network's optimization is done by searching in the parameter space a set of weights that minimize the error between the predicted 3D points and the detailed long-range information provided by the recording setup's long-range lidar unit thus comparing inferred distances of the inference setup to measurable distances 29, 33 in the recording setup. The Neural Network's backbone architecture can be Convolutional Neural Network in an autoencoder setup e.g. U-Net or more modern versions. The current invention's scope is not the performance enhancement of the backbone's internal structure, but rather the setup and steps described above. The invention's production vehicle setup emulates a long-range lidar unit with the above detailed fusion methodology running real-time in the production vehicle.

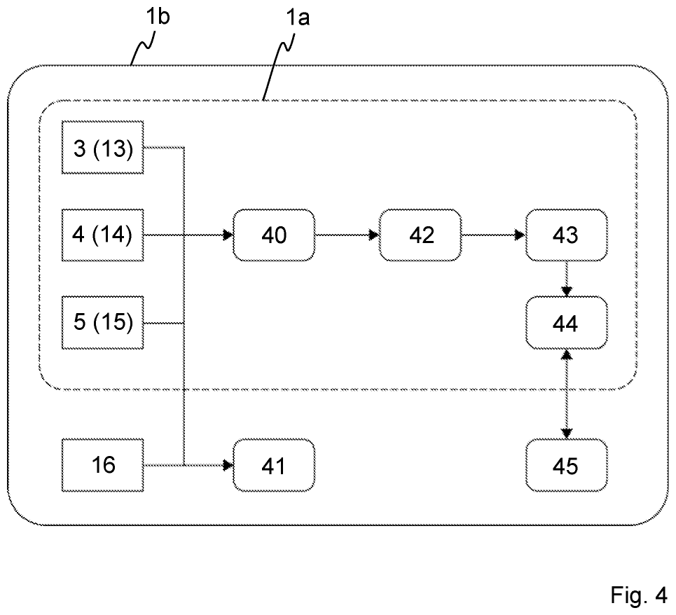

The described embodiments refer to a computer program that can be executed on one or more GPUs (General Processing Units), CPUs (Computer Processing Units) or dedicated Neural Network accelerators, together with a described vehicle sensor setup. One embodiment of the invention can have a single-beam long-range lidar unit as a complementary long-range but ultra-low resolution sensor. Thus e.g. flash lidar and single beam long-range lidar and camera fusion is done in inference time in the vehicle. A similar beam lidar unit could be used (but a long-range version instead of short-range infrared sensor). Both the flash lidar and the long-range single beam lidar or all three sensors together with the camera could be integrated into a single physical sensor system (the three sensors can be arranged in one physical housing) so called long-range ground truth lidar 16 as shown in FIG. 4, wherein both first sensor setup (production vehicle 1a) and second sensor setup (training vehicle 1b) is shown. It is preferred that the camera, the flash lidar and the single-beam long-range lidar have the same frame rate (preferably designing to match the frame rate of the Flash lidar). According to a preferred design the camera and the flash lidar frame rate synchronization is already carried out in the factory process. In addition, the long-range radar 4 (or 14) can also be a long-range lidar sensor. Furthermore, FIG. 4 shows an example of method steps for processing the sensor data: In steps 40 and 41 the sensor data is transformed to a common coordinate system. In step 42 the data of the coordinate system is projected to camera plane and further concatenated (Concatenation 43) for a depth prediction by neural network for all camera pixels (step 44). Furthermore, supervised learning optimization 45 can also be used for step 44 or step 44 can be used to improve the supervised learning optimization 45. Another, alternative embodiment of the invention can use a long-range radar with a single or multiple beams as a complementary long-range but ultra-low resolution sensor. Thus, e.g., flash lidar, long-range radar and camera fusion is also done in inference time in the vehicle.

All in all as an exemplary embodiment the production vehicle setup includes a short-range lidar and an additional “single beam lidar” or similar (2-5 beams), a main lidar to extend the short-range, like a high flash lidar (e.g. with an effective range up to 20 m with 4096 points) and a complementary long-range “single static beam” lidar (could be more than one beam, but “low beam count individual static beam”; e.g. 1-5 up to the desired range extension, e.g. 40 m, 60 m, 80 m, 100 m) individual static beams (or a radar sensor, which also typically has one beam or up to a few beams only). An exemplary embodiment for recording vehicle setup includes all sensors of the production vehicle setup and a long-range dense ground truth lidar, e.g., with an effective range up to 120 m with dense points (for example this sensor comprises rotating multiple beams, so called “scanning lidar” and also a long-range). In the end the recoding vehicle having all named types of sensors, but the production vehicle having only the “single beam” (or low number individual static non-moving point beams) and the high flash lidar, wherein the range of the long-range dense ground truth lidar can be emulated, for which the single long-range beam helps by having just a few (1-3) long-range point measurements (anchor points) to calibrate the prediction of distances outside of the high flash lidars 20 m range.

### REFERENCE NUMBERS

1 Production vehicle
2 Control unit
3 Short-range lidar sensor
4 Long-range radar sensor
5 Camera
11 Training vehicle
12 Control unit
13 Short-range lidar sensor
14 Long-range radar sensor
15 Camera
16 Long-range ground truth lidar sensor
20 Reflection
21 Reflection
22 Reflection
23 Single radar (or lidar) beam
24 Effective range of long-range auxiliary sensor
25 Distance (between reflections 20 and 21)
26 Effective range of short-range lidar
27 Coverage of short-range lidar
28 Anchor point
29 Distance (between reflections 20 and 22)
30 Coverage of long-range ground truth sensor
31 Detection range of long-range ground truth sensor
32 Multi radar (or lidar) beams
33 Distance (between reflections 21 and 22 or between two anchor points)
40 Transformation to common coordinate system
41 Transformation to common coordinate system
42 Projection to camera plane
43 Concatenation
44 Depth prediction
45 Supervised learning optimization

1-15. (canceled)

16. A sensor system for a vehicle, comprising:
a first sensor setup having a first short-range sensor and a first long-range auxiliary sensor configured to provide an anchor point measurement;
a second sensor setup having
a second short-range sensor,
a second long-range auxiliary sensor configured to provide an anchor point measurement, and
a long-range ground truth sensor, wherein
wherein the sensors of first and second sensor setups each have a sensor range and provide sensor data for reflection detection;
a neural network,
the neural network trained by:
detecting reflections in the surrounding of the vehicle by using sensor data of the second sensor setup,
determining an anchor point of a reflection which is out of a detection range of the second short-range sensor by using anchor point measurement of the second long-range auxiliary sensor, and
providing ground truth by determining the distances between the anchor point and the other reflections by using the sensor data of the long-range ground truth sensor, and
the neural network further configured to
detect reflections in the surrounding of the vehicle using sensor data of the second sensor setup,
determine anchor points of a reflection by using anchor point measurement of the first long-range auxiliary sensor,
determine the distances between the anchor point and other reflections in the detection range of short-range sensor by using the sensor data of short-range sensor, and
infer the distances between the anchor point and other reflections out of the detection range of short-range sensor by using the pro-vided ground truth of the neural network.

17. The system according to claim 16, wherein the short-range sensor in the first and/or the second sensor setup is a short-range flash lidar sensor.

18. The system according to claim 16, wherein the long-range auxiliary sensor which provides an anchor point measurement in the first and/or the second sensor setup is a radar sensor or a long-range lidar sensor.

19. The system according to claim 16, wherein the long-range auxiliary sensor comprises a single-beam or a multi-beam configuration.

20. The system according to claim 16, wherein the first sensor setup and/or the second sensor setup includes a camera, which provides images and/or pixels as sensor data which are also used as input for the neural network.

21. The system according to claim 20, wherein the neural network infers the location of camera pixels which have no other input sensor data or anchor point measurement associated.

22. The system according to claim 16, wherein the long-range ground truth sensor is a long-range ground truth lidar sensor.

23. The system according to claim 16, wherein a sensor fusion of sensor data of the sensors of the first sensor setup is performed.

24. The system according to claim 16, wherein the short-range sensor is a short-range flash lidar sensor and the long-range auxiliary sensor is a long-range lidar sensor.

25. The system according to claim 24, wherein the short-range lidar sensor and the long-range lidar sensor have the same frame rate.

26. The system according to claim 16, wherein the sensors of the first sensor setup and/or the sensors of the second sensor setup are arranged together with the corresponding camera in one housing.
